(19) United States
(12) Patent Application Publication
(10) Pub. No.: US 2024/0059311 A1
(43) Pub. Date: Feb. 22, 2024

(54) AUTOMATED WINDOW CLOSURE

(71) Applicant: GM Cruise Holdings LLC, San Francisco, CA (US)

(72) Inventors: Bonnie Lin, El Cerrito, CA (US); Ashley MG Anderson, Los Angeles, CA (US); Theresa Foy, San Francisco, CA (US); Sergiu Dan Ion, San Francisco, CA (US); Sagar Doshi, Newark, CA (US); Oscar Espinoza, Dublin, CA (US)

(21) Appl. No.: 17/890,455

(22) Filed: Aug. 18, 2022

(51) Int. Cl. B60W 60/00; G06V 20/59

(52) U.S. Cl. CPC B60W 60/001; G06V 20/593; B60W 2520/10; B60W 2710/30; B60W 2420/42; B60W 2420/52

(57) ABSTRACT

The disclosed technology provides solutions for improving vehicle safety and in particular, for improving pedestrian safety when automatically closing windows of an autonomous vehicle (AV). The disclosed technology includes a process for automatically closing one or more windows of and AV, including steps for determining if one or more passengers are present inside a cabin of an autonomous vehicle (AV), determining if a speed of the AV has exceeded a predetermined speed threshold for longer than a predetermined time threshold, and automatically returning one or more windows of the AV to a closed position if it is determined that there are no passengers present inside the cabin of the AV and the speed of the AV has exceeded the predetermined speed threshold for a time duration that exceeds the predetermined time threshold. Systems and machine-readable media are also provided.

### BACKGROUND

### 1. Technical Field

The disclosed technology provides solutions for improving vehicle safety and in particular, for improving pedestrian safety when automatically closing windows of an autonomous vehicle (AV).

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning and obstacle avoidance.

### BRIEF DESCRIPTION OF THE DRAWINGS

Certain features of the subject technology are set forth in the appended claims. However, the accompanying drawings, which are included to provide further understanding, illustrate disclosed aspects and together with the description explain the principles of the subject technology. In the drawings:

FIG. 1 illustrates an example of a control system that can be used to automatically close windows of an AV, according to some aspects of the disclosed technology.

FIG. 2 illustrates a flow diagram of example control logic that can be used to implement an automatic window closure process, according to some aspects of the disclosed technology.

FIG. 3 illustrates a flow diagram of an example process for automatically returning one or more windows of an AV to a closed position, according to some aspects of the disclosed technology.

FIG. 4 illustrates an example system environment that can be used to facilitate AV dispatch and operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

After completing the drop-off of a passenger by an autonomous vehicle (AV) ride hailing service, it is desirable to return all AV windows to an upright/closed position, e.g., for security reasons, and to avoid the ingress of dirt, moisture, or other debris into the AV cabin. Some autonomous vehicles (AVs) do not utilize force (torque) sensors to monitor an amount of force applied when closing various windows. Because AVs lack human drivers to monitor when passengers or other pedestrians may be blocking the path of a closing window, some conventional AV's can pose a danger to passengers or other passerby that may reach or lean into the AV while windows are closing.

Aspects of the disclosed technology provide solutions for improving vehicle safety and in particular, for improving safety when automatically closing windows of an autonomous vehicle (AV). AV window closure can be controlled by logic that is configured to ensure that passengers are not present in the AV cabin, or likely to be outside of an AV window, while the window closure is performed.

AV window closure may be performed in response to the occurrence of certain prior conditions. For example, window closure may only be attempted when it is determined that (1) no passengers are inside a cabin of the AV, and that (2) the AV has reached and sustained a (predetermined) threshold speed for some (predetermined) time period threshold. By ensuring that no passengers occupy the AV cabin, the control logic reduces the likelihood that passengers or other occupants may be injured by the window closure. Additionally, by effecting window closure once the AV has reached a predetermined speed for a predetermined duration, the control logic also reduces the likelihood that any passerby may be injured, for example, if/when reaching into an open window of the AV.

In some implementations, the AV may be configured to automatically close windows if it is determined that no passengers are occupying the AV cabin, and if it is determined that one or more pedestrians are approaching the vehicle. In such instances, required preconditions of a minimum AV speed for a minimum time duration may be suspended. In such instances, AV sensor data (e.g., camera and/or LiDAR data) may be used to detect the approach of pedestrians and trigger automatic window closure, e.g., to prevent any interference with, or damage to, the AV that can result from pedestrians reaching into (or tossing items into) the AV cabin.

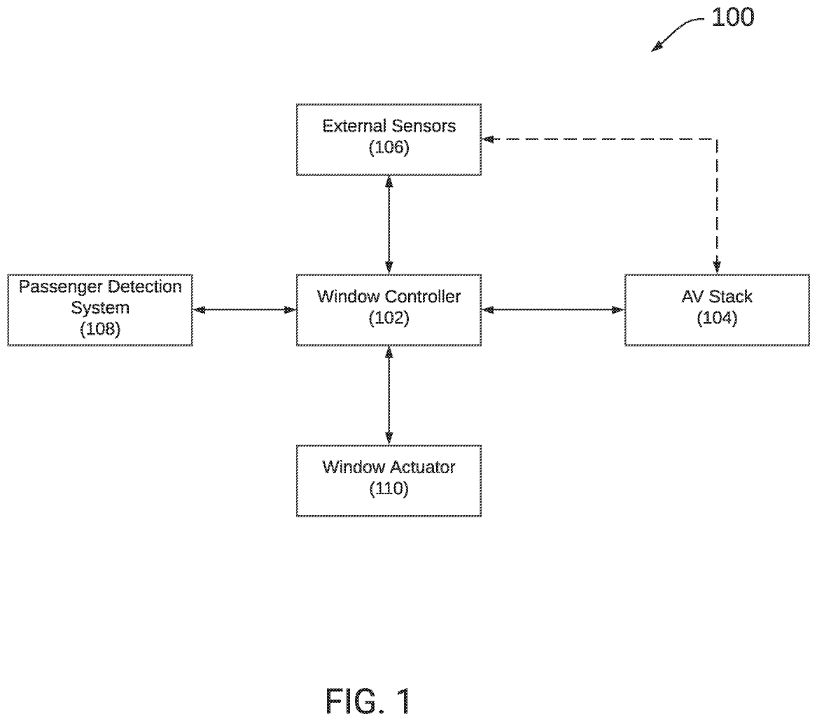

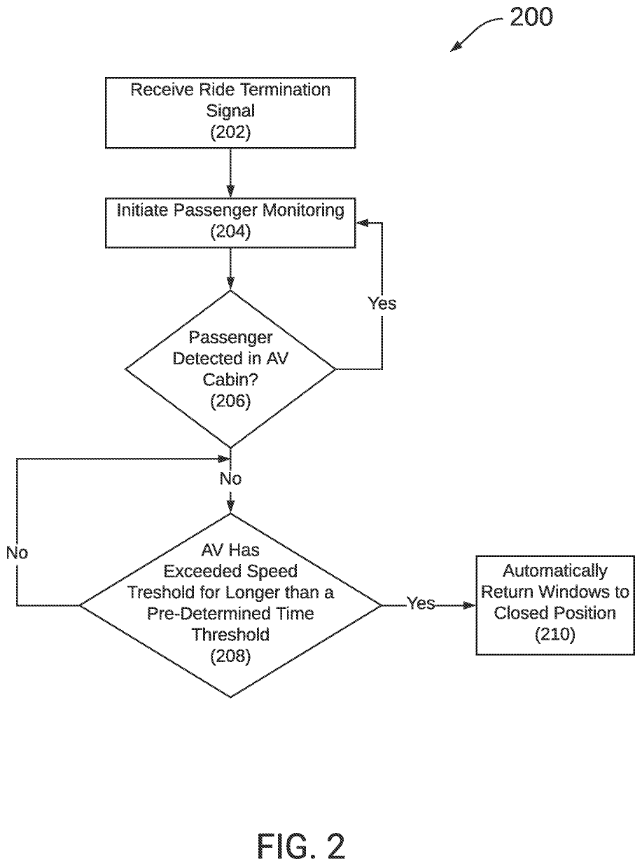

FIG. 1 illustrates an example of a control system 100 that can be used to automatically close windows of an AV. Control system 100 includes a window controller 102 that can implement control logic, e.g., to determine when AV conditions are appropriate to initiate an automatic window closure event, as described in further detail with respect to FIG. 2, below. Window controller 102 can receive an indication from AV stack 104 that a ride or passenger drop-off has been completed. For example, a remote dispatch management service (not illustrated) can communicate to the AV via a communications module of AV stack 104, to indicate that a ride service has ended. Alternatively, determinations of ride service termination may be made locally at the AV, for example, using AV stack 104 as well as sensor data collected from one or more external sensors 106 and/or a passenger detection system 108, that are in communication with window controller 102.

The detection of a ride service termination can be used by window controller 102 to trigger a determination as to whether any passengers/occupants remain in a cabin of the AV. For example, passenger detection system 108, which can include various in-cabin sensors, can be used to determine whether any passengers remain in the AV after the ride service has ended. Passenger detection system 108 can include various in-cabin sensors, including, but not limited to one or more seat occupancy sensors, seatbelt sensors, door sensors, cameras, and/or LiDAR sensors, etc., that can be used to collect sensor data about various areas within the AV cabin. By way of example, seat occupancy sensors may be used to detect the presence of passengers in/on one or more seats within the cabin. Similarly, optical sensors (e.g., cameras and/or LiDAR sensors) may be used to detect occupancy within the AV cabin, e.g., in areas around the cabin floor and/or other locations not addressable using seat occupancy sensors.

If it is determined that no passengers remain in the AV, then window controller 102 can determine if other pre-conditions have been met before window closure is initiated, e.g., using window actuator 110. As discussed above, in some implementations, pre-conditions regarding AV speed, and speed-duration can be requisite before window controller 102 can initiate window closure via window actuator 110. In some instances, window closure may be triggered if it is determined that the AV has reached a predetermined (minimum) speed threshold and has sustained the minimum speed for a predetermined time duration. By way of example, the predetermined speed threshold may be 5 mph, whereas the predetermined time duration may be 1 minute. A larger (or smaller) predetermined speed threshold and/or predetermined time threshold may be used, without departing from the scope of the disclosed technology. Additionally, it is understood that the predetermined speed and/or predetermined time threshold may be a configurable setting or may be based on information about the environment. For example, lower or higher thresholds may be set, depending on the scene complexity of the environment (e.g., scene business) around the AV and/or based on metrics regarding a number of pedestrians that are proximate to the AV, etc. Information about the AV speed and/or duration-at-speed can be obtained by window controller 102 from AV stack 104, and/or from sensor data received from external sensors 106. Further details regarding control logic implemented by window controller 102 are provided with respect to FIG. 2, below.

FIG. 2 illustrates a flow diagram of example control logic 200 that can be used to implement an automatic window closure process. At block 202, a ride termination signal is received at an AV, indicating the termination of a ride service. As discussed above, the ride termination signal can be received via a communication stack (or module) of the AV, and provided to a window controller (e.g., window controller 102) that is configured to control the closure (and opening) of one or more AV windows.

In response to receipt of the ride termination signal (block 202), the AV can be configured to trigger or initiate a passenger monitoring process (block 204). Passenger monitoring can be used to determine if any occupants remain in a cabin of the AV. As discussed above, monitoring can be performed using a passenger detection system, e.g., passenger detection system 108, which can be configured to collect and analyze sensor data about the AV cabin, e.g., to determine whether any passengers remain after completion of the ride service (block 206). If it is determined that one or more passengers remain in the AV cabin, then logic 200 can revert to block 204 and passenger occupancy monitoring can continue. In such instances, and to avoid the possibility of passenger injury, automatic window closure is not initiated.

Alternatively, if at block 206 it is determined that no passengers remain in the AV, then logic 200 can advance to block 208 in which it can be determined if the AV has reached a predetermined minimum speed threshold and has maintained the minimum speed for a predetermined time duration. As mentioned above, the predetermined speed threshold and/or predetermined time threshold may be fixed values, for example, that are indicated by a user-configurable parameter. In other instances, each threshold type may be dynamically set, e.g., based on AV location and/or environmental conditions around the AV. By way of example, the predetermined speed threshold (or speed threshold) may be 5 mph, whereas the predetermined time threshold (or time duration) may be 1 minute.

If it is determined that the AV has not reached the predetermined speed threshold and/or has not maintained the predetermined speed for the predetermined time duration, then logic 200 can revert to block 208, and threshold monitoring can persist. Alternatively, if it is determined that the AV has met or exceeded the speed threshold for a duration longer than the predetermined time threshold duration, then logic 200 can advance to block 210, and one or more windows of the AV can be automatically returned to a closed (or upward) position.

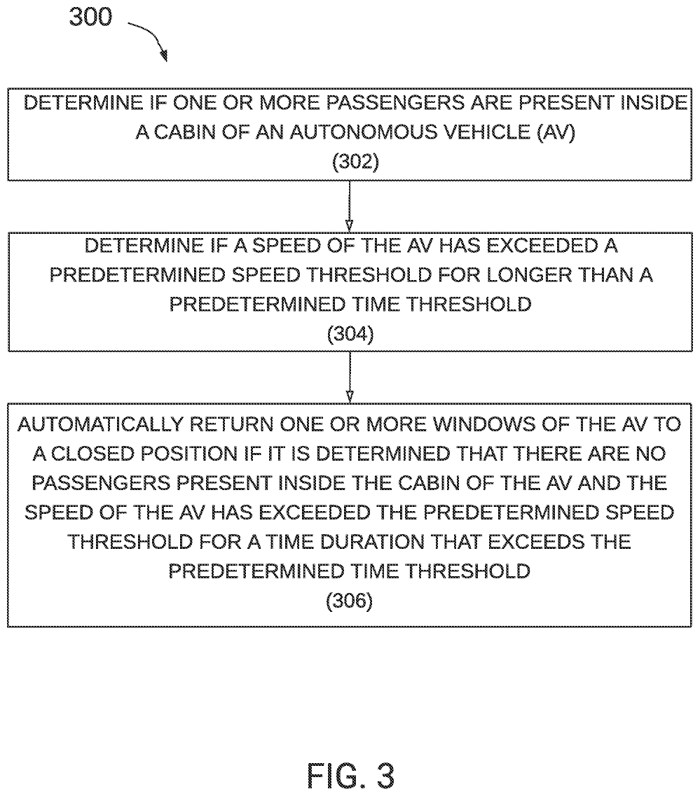

FIG. 3 illustrates a flow diagram of an example process 300 for automatically returning one or more windows of an AV to a closed position.

At step 302, the process 300 includes determining, via a passenger detection system, if one or more passengers are present inside a cabin of an autonomous vehicle (AV). As discussed above, the passenger detection system can include various in-cabin sensors to determine whether any passengers remain in the AV after the ride service has ended. In some approaches, determinations regarding the presence (or remaining presence) of passengers in the AV can be made in response to (or triggered by) the receipt of a ride-completion signal/command at the AV. By way of example, a remote management system may signal ride completion to the AV upon termination of a ride service, thereby triggering a determination, using in-cabin sensors, as to whether any passengers remain in the cabin. The various in-cabin sensors can include, but are not limited to one or more seat occupancy sensors, seatbelt sensors, cameras, door sensors, and/or LiDAR sensors, etc., that can be used to collect sensor data about various areas within the AV cabin.

At step 304, the process 300 includes determining if a speed of the AV has exceeded a predetermined speed threshold for longer than a predetermined time threshold. By way of example, the predetermined speed threshold (or speed threshold) may be 5 mph, whereas the predetermined time threshold (or time duration threshold) may be 1 minute. It is understood that the speed threshold and/or the time threshold may be differently configured without departing from the scope of the disclosed technology. For example, the speed threshold may be 3 mph, 7 mph or 10 mph, etc. The time threshold may be 15 seconds, 30 seconds, or 2 minutes, etc. In some instances, the speed threshold may be set based on the time threshold, or vice versa. For example, a lower time threshold may be applied when a higher speed threshold is used, and vice versa.

In some applications, the time threshold and/or speed threshold may be set based on environmental conditions around the AV, such as a location of the AV, measures of scene complexity, and/or the detected presence proximately located pedestrians. That is, higher thresholds of speed and time may be used in situations where a greater number of pedestrians are detected, and/or where one or more pedestrians are identified in locations that are proximate to the AV, such as within reaching distance of the AV's doors or windows. By way of example, the time threshold may be increased to 1.5 minutes in locations where crowds/pedestrians are detected.

At step 304, the process 300 includes automatically returning one or more windows of the AV to a closed position if it is determined that there are no passengers present inside the cabin of the AV and the speed of the AV has exceeded the predetermined speed threshold (e.g., 5 mph) for a time duration exceeding the predetermined time threshold (e.g., 1 min).

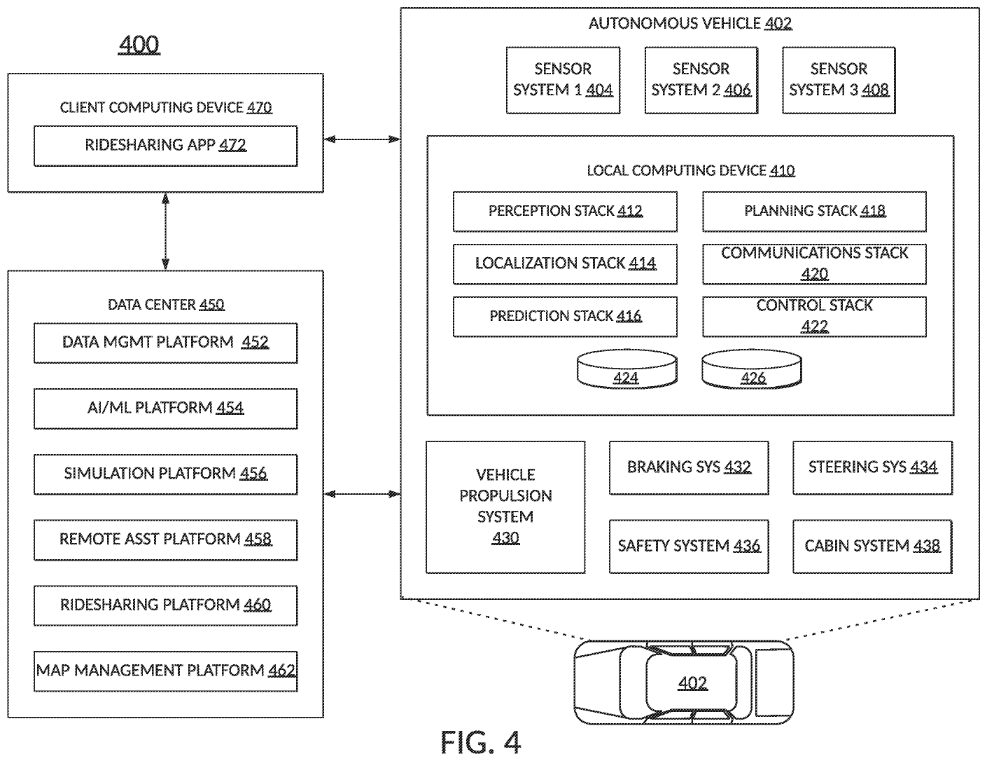

FIG. 4 illustrates an example of an AV management system 400. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 400 includes an AV 402, a data center 150, and a client computing device 170. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 402 can navigate roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), optical sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

The AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some embodiments, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a prediction stack 416, a planning stack 418, a communications stack 420, a control stack 422, an AV operational database 424, and an HD geospatial database 426, among other stacks and systems.

The perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 414 can determine the AV's position and orientation (pose) using different methods from multiple systems (e.g., GPS, IMUs, cameras, LIDAR, RADAR, ultrasonic sensors, the HD geospatial database 426, etc.). For example, in some embodiments, the AV 402 can compare sensor data captured in real-time by the sensor systems 404-408 to data in the HD geospatial database 426 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The prediction stack 416 can receive information from the localization stack 414 and objects identified by the perception stack 412 and predict a future path for the objects. In some embodiments, the prediction stack 416 can output several likely paths that an object is predicted to take along with a probability associated with each path. For each predicted path, the prediction stack 416 can also output a range of points along the path corresponding to a predicted location of the object along the path at future time intervals along with an expected error value for each of the points that indicates a probabilistic deviation from that point.

The planning stack 418 can determine how to maneuver or operate the AV 402 safely and efficiently in its environment. For example, the planning stack 418 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. The planning stack 418 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct the AV 402 to go around the block instead of blocking a current lane while waiting for an opening to change lanes.

The control stack 422 can manage the operation of the vehicle propulsion system 430, the braking system 432, the steering system 434, the safety system 436, and the cabin system 438. The control stack 422 can receive sensor signals from the sensor systems 404-408 as well as communicate with other stacks or components of the local computing device 410 or a remote system (e.g., the data center 450) to effectuate operation of the AV 402. For example, the control stack 422 can implement the final path or actions from the multiple paths or actions provided by the planning stack 418. This can involve turning the routes and decisions from the planning stack 418 into commands for the actuators that control the AV's steering, throttle, brake, and drive unit.

The communications stack 420 can transmit and receive signals between the various stacks and other components of the AV 402 and between the AV 402, the data center 450, the client computing device 470, and other remote systems. The communications stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 426 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408, stacks 412-422, and other components of the AV 402 and/or data received by the AV 402 from remote systems (e.g., the data center 450, the client computing device 470, etc.). In some embodiments, the raw AV data can include HD LIDAR point cloud data, image data, RADAR data, GPS data, and other sensor data that the data center 450 can use for creating or updating AV geospatial data or for creating simulations of situations encountered by AV 402 for future testing or training of various machine learning algorithms that are incorporated in the local computing device 410.

The data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and the client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, and a ridesharing platform 460, and a map management platform 462, among other systems.

The data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the map management platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the map management platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from a cartography platform (e.g., map management platform 462); modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 472. The client computing device 470 can be a customer's mobile computing device or a computing device integrated with the AV 402 (e.g., the local computing device 410). The ridesharing platform 460 can receive requests to pick up or drop off from the ridesharing application 472 and dispatch the AV 402 for the trip.

Map management platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially referenced data. The raw data can be processed, and map management platform 462 can render base representations (e.g., tiles (2D), bounding volumes (3D), etc.) of the AV geospatial data to enable users to view, query, label, edit, and otherwise interact with the data. Map management platform 462 can manage workflows and tasks for operating on the AV geospatial data. Map management platform 462 can control access to the AV geospatial data, including granting or limiting access to the AV geospatial data based on user-based, role-based, group-based, task-based, and other attribute-based access control mechanisms. Map management platform 462 can provide version control for the AV geospatial data, such as to track specific changes that (human or machine) map editors have made to the data and to revert changes when necessary. Map management platform 462 can administer release management of the AV geospatial data, including distributing suitable iterations of the data to different users, computing devices, AVs, and other consumers of HD maps. Map management platform 462 can provide analytics regarding the AV geospatial data and related data, such as to generate insights relating to the throughput and quality of mapping tasks.

In some embodiments, the map viewing services of map management platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridesharing platform 460 may incorporate the map viewing services into the client application 472 to enable passengers to view the AV 402 in transit en route to a pick-up or drop-off location, and so on.

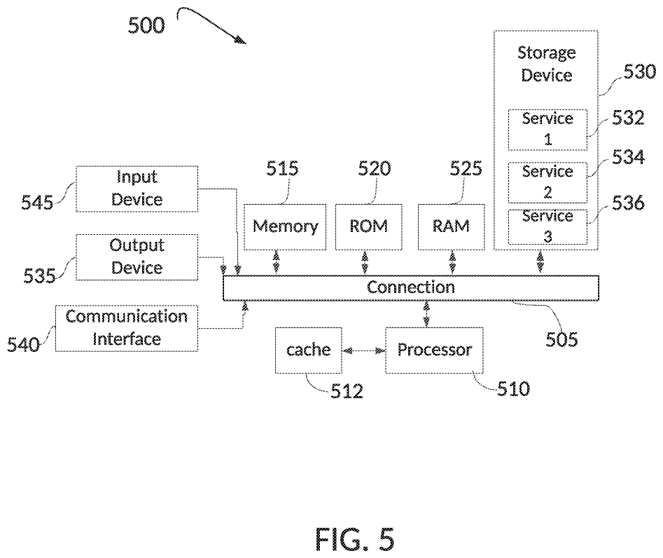

FIG. 5 illustrates an example apparatus (e.g., a processor-based system) with which some aspects of the subject technology can be implemented. For example, processor-based system 500 can be any computing device making up internal computing system 510, remote computing system 550, a passenger device executing the rideshare app 570, internal computing device 530, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. An apparatus comprising:
at least one memory; and
at least one processor coupled to the at least one memory, the at least one processor configured to:
determine, via a passenger detection system, if one or more passengers are present inside a cabin of an autonomous vehicle (AV);
determine if a speed of the AV has exceeded a predetermined speed threshold for longer than a predetermined time threshold; and
automatically return one or more windows of the AV to a closed position if it is determined that there are no passengers present inside the cabin of the AV and the speed of the AV has exceeded the predetermined speed threshold for a time duration that exceeds the predetermined time threshold.

2. The apparatus of claim 1, wherein the passenger detection system comprises one or more seat sensors.

3. The apparatus of claim 1, wherein the passenger detection system comprises one or more cameras disposed within the cabin of the AV, and wherein the passenger detection system is configured to determine if one or more passengers are present inside the cabin based on image data collected by the one or more cameras.

4. The apparatus of claim 1, wherein the at least one processor is configured to:
automatically re-determine if the speed of the AV has exceeded the predetermined speed threshold for longer than the predetermined time threshold, if it is determined that no passengers are present inside the cabin of the AV.

5. The apparatus of claim 1, wherein the passenger detection system comprises one or more external vehicle sensors, and wherein the passenger detection system is further configured to detect an approach of one or more pedestrians towards the AV.

6. The apparatus of claim 5, wherein the at least one processor is further configured to:
automatically return one or more windows of the AV to the closed position if it is determined that one or more pedestrians are approaching the AV.

7. The apparatus of claim 5, wherein the one or more external vehicle sensors comprises a camera, a Light Detection and Ranging (LiDAR) sensor, or a combination thereof.

8. A computer-implemented method, comprising:
determining, using a passenger detection system, if one or more passengers are present inside a cabin of an autonomous vehicle (AV);
determining if a speed of the AV has exceeded a predetermined speed threshold for longer than a predetermined time threshold; and
automatically returning one or more windows of the AV to a closed position if it is determined that there are no passengers present inside the cabin of the AV and the speed of the AV has exceeded the predetermined speed threshold for a time duration that exceeds the predetermined time threshold.

9. The computer-implemented method of claim 8, wherein the passenger detection system comprises one or more seat sensors.

10. The computer-implemented method of claim 8, wherein the passenger detection system comprises one or more cameras disposed within the cabin of the AV, and wherein the passenger detection system is configured to determine if one or more passengers are present inside the cabin based on image data collected by the one or more cameras.

11. The computer-implemented method of claim 8, further comprising:
automatically re-determining if the speed of the AV has exceeded the predetermined speed threshold for longer than the predetermined time threshold, if it is determined that no passengers are present inside the cabin of the AV.

12. The computer-implemented method of claim 8, wherein the passenger detection system comprises one or more external vehicle sensors, and wherein the passenger detection system is further configured to detect an approach of one or more pedestrians towards the AV.

13. The computer-implemented method of claim 12, further comprising:
automatically returning one or more windows of the AV to the closed position if it is determined that one or more pedestrians are approaching the AV.

14. The computer-implemented method of claim 12, wherein the one or more external vehicle sensors comprises a camera, a Light Detection and Ranging (LiDAR) sensor, or a combination thereof.

15. A non-transitory computer-readable storage medium comprising at least one instruction for causing a computer or processor to:
determine, via a passenger detection system, if one or more passengers are present inside a cabin of an autonomous vehicle (AV);
determine if a speed of the AV has exceeded a predetermined speed threshold for longer than a predetermined time threshold; and
automatically return one or more windows of the AV to a closed position if it is determined that there are no passengers present inside the cabin of the AV and the speed of the AV has exceeded the predetermined speed threshold for a time duration that exceeds the predetermined time threshold.

16. The non-transitory computer-readable storage medium of claim 15, wherein the passenger detection system comprises one or more seat sensors.

17. The non-transitory computer-readable storage medium of claim 15, wherein the passenger detection system comprises one or more cameras disposed within the cabin of the AV, and wherein the passenger detection system is configured to determine if one or more passengers are present inside the cabin based on image data collected by the one or more cameras.

18. The non-transitory computer-readable storage medium of claim 15, wherein the at least one instruction is further configured to cause the computer or processor to:
automatically re-determine if the speed of the AV has exceeded the predetermined speed threshold for longer than the predetermined time threshold, if it is determined that no passengers are present inside the cabin of the AV.

19. The non-transitory computer-readable storage medium of claim 15, wherein the passenger detection system comprises one or more external vehicle sensors, and wherein the passenger detection system is further configured to detect an approach of one or more pedestrians towards the AV.

20. The non-transitory computer-readable storage medium of claim 19, wherein the at least one instruction is further configured to cause the computer or processor to:
automatically return one or more windows of the AV to the closed position if it is determined that one or more pedestrians are approaching the AV.
